(19) United States
(12) Patent Application Publication
(10) Pub. No.: US 2009/0326733 A1
(43) Pub. Date: Dec. 31, 2009

(54) METHOD AND ARRANGEMENT FOR DETERMINING AN UPDATED WHEEL CIRCUMFERENCE OF AT LEAST ONE WHEEL DISPOSED ON A VEHICLE

(76) Inventors: Andreas Abele, Barbing (DE); Alexander Kalbeck, Burglengenfeld (DE)

Correspondence Address: King & Spalding LLP, 401 Congress Avenue, Suite 3200, Austin, TX, 78701, US

(21) Appl. No.: 12/518,986

(22) PCT Filed: Oct. 31, 2007
(86) PCT No.: PCT/EP2007/061747

§ 371 Date: Aug. 28, 2009

(30) Foreign Application Priority Data
Dec. 12, 2006 (DE) 10 2006 058 567.4

(51) Int. Cl. B60W 40/10; G01S 1/00

(52) U.S. Cl. 701/1; 342/357.09

(57) ABSTRACT

In a method and an arrangement for the determination of an updated wheel circumference (U*) of at least one wheel (R) arranged on a vehicle, during which at least one wheel circumference (U) is assigned to at least one wheel (R) in a control unit (CU), and during which the wheel speed (RaV) is determined by means of the control unit (CU) according to the speed of rotation (RoV) of the at least one wheel (R) and according to the assigned wheel circumference (U), advantageously, a reference speed (RefV) of the vehicle and/or the wheel (R) is determined which is independent of the determined wheel speed (RaV). The discrepancy (V) between the at least one wheel speed (RaV) and the reference speed (RefV) is detected and the updated wheel circumference (U*) of the at least one wheel (R) is determined according to the discrepancy (V).

### CROSS-REFERENCE TO RELATED APPLICATIONS

This application is a U.S. National Stage Application of International Application No. PCT/EP2007/061747 filed Oct. 31, 2007, which designates the United States of America, and claims priority to German Application No. 10 2006 058 567.4 filed Dec. 12, 2006, the contents of which are hereby incorporated by reference in their entirety.

### TECHNICAL FIELD

The invention relates to a method and an arrangement for determining an updated wheel circumference of at least one wheel disposed on a vehicle.

### BACKGROUND

In a large number of vehicles currently on the market, particularly motor vehicles, the vehicle speed is determined by evaluating and/or comparing the individual wheel speeds of the vehicle. In the following, the term wheel speed will be taken to mean the rotational speed of a wheel disposed on a vehicle.

The speed of the vehicle or more specifically the individual wheel speeds constitute parameters which undergo further processing by a plurality of electronic driver assistance systems provided in the vehicle, such as an anti-lock braking system (ABS), electronic stability control (ESC), etc. The vehicle speed or more specifically the individual wheel speeds must therefore be determined with the utmost accuracy and reliability, particularly in order to enable, for example, brake applications on individual wheels by means of ESC or ABS to be very precisely controlled.

To determine the individual wheel speeds, measuring systems are already known via which the rotation speed of the rotatably mounted wheel is determined. If the wheel circumference of the tire on the wheel rim is known, the respective wheel speed can be determined on the basis of the rotation speed determined, the wheel speed determined being directly proportional to the circumference of the tire on the wheel rim, which is ideally constant for a particular tire type.

In practice, however, the circumference of a tire depends, for example, on the inflation pressure present, dynamic effects and also tire wear, i.e. the wheel speeds determined may be subject to error due to the wheel circumference stored in the measurement system and used for determining the wheel speed being at variance with the current wheel circumference. Particularly in the event of a tire being damaged and replaced by a spare wheel in as-new condition in the trunk, the wheel circumferences of the spare wheel and the other wheels may be different, resulting in significant measurement errors when determining the individual wheel speeds. However, modern brake control systems are capable of allowing for such changes in individual wheel-specific parameters. For example, the individual wheel speeds are mutually compensated for determining the vehicle speed.

Nevertheless, if a plurality of wheels with a completely different tire circumference from that of the previous wheels are installed simultaneously, such as when changing over from summer to winter tires, known control systems are currently unable to detect and if necessary update the new wheel circumference automatically, possibly causing the individual wheel speeds to differ by several percent.

### SUMMARY

Proceeding from the prior art expounded here, according to various embodiments, a method and an arrangement for determining the updated wheel circumference of at least one wheel disposed on a vehicle can be specified, in order thereby to ensure highly accurate determination of the individual wheel speeds as a function of the rotation speed of the respective wheel and of the updated wheel circumference.

According to an embodiment, a method for determining an updated wheel circumference of at least one wheel disposed on a vehicle, wherein the at least one wheel is assigned at least one wheel circumference in a control unit and wherein the wheel speed is determined by means of the control unit as a function of the rotation speed of the at least one wheel and as a function of the assigned wheel circumference,

May comprise the steps of: a reference speed of the vehicle and/or of the wheel which is independent of the determined wheel speed is determined, the deviation of the at least one wheel speed from the reference speed is determined and the updated wheel circumference of the at least one wheel is determined as a function of the deviation.

According to a further embodiment, the reference speed can be determined by integrating an acceleration signal indicative of the acceleration of the vehicle. According to a further embodiment, the reference speed can be determined by evaluating a GPS speed signal or at least two GPS position signals via a global positioning system. According to a further embodiment, the reference speed can be determined by evaluating an acceleration signal and/or speed signal indicative of the acceleration of the vehicle provided by an optical system. According to a further embodiment, the at least one wheel speed and/or the reference speed can be determined as a function of the particular driving situation. According to a further embodiment, the deviation of the at least one wheel speed from the reference speed may be compared with a predefined minimum and/or maximum deviation and if the minimum deviation is undershot or the maximum deviation is exceeded by the deviation determined, the wheel speed and/or the reference speed is re-determined. According to a further embodiment, a mean deviation can be determined on a current basis by evaluating deviations determined at different times. According to a further embodiment, the deviation can be compared with the current mean deviation and the deviation is discarded if a predefined value is exceeded or undershot. According to a further embodiment, the updated wheel circumference can be determined as a function of the current mean deviation. According to a further embodiment, a plurality of reference tire circumferences can be stored in the control unit, one of the reference tire circumferences being assigned to a tire type in each case. According to a further embodiment, the current wheel circumferences of the wheels provided on the vehicle can be determined approximately simultaneously and that if one or more current wheel circumferences deviate from the determined current wheel circumferences of the other wheels, all the current wheel circumferences determined are discarded.

According to another embodiment, an arrangement for determining the updated wheel circumference of at least one wheel mounted on a vehicle, may comprise a control unit and at least one first measuring unit, wherein the at least one wheel is assigned at least one wheel circumference in the control unit, the first measuring unit being designed to measure the rotation speed of the at least one wheel, and the control unit to determine the wheel speed of the at least one wheel as a function of the measured rotation speed and the assigned wheel circumference, wherein a second measuring unit is provided for determining a reference speed of the vehicle and/or of the wheel that is independent of the determined wheel speed,

And wherein the control unit incorporates an evaluation and control routine for determining the deviation of the at least one wheel speed from the reference speed and for determining an updated wheel circumference as a function of the deviation determined.

According to a further embodiment, the second measuring unit can be constituted by an accelerometer unit. According to a further embodiment, the second measuring unit can be constituted by a global positioning system or navigation system. According to a further embodiment, the second measuring unit can be constituted by an optical system.

### BRIEF DESCRIPTION OF THE DRAWINGS

The invention will now be explained in greater detail by means of exemplary embodiments with reference to the accompanying drawings, in which:

FIG. 1 shows, by way of example, a schematic block diagram of an arrangement for updating a wheel circumference of at least one wheel mounted on a vehicle,

FIG. 2 shows, by way of example, a side view of the wheel according to FIG. 1 and

FIG. 3 shows, by way of example, a flow chart of the individual method steps of the method for determining an updated wheel circumference.

### DETAILED DESCRIPTION

An essential aspect of the method according to various embodiments is considered to be that a vehicle and/or wheel reference speed is determined which is independent of the wheel speed determined. Then, the deviation of the at least one wheel speed from the reference speed is determined and is updated depending on the determined deviation of the wheel circumference of the at least one wheel.

One arrangement may have advantageously a second measuring unit for determining a vehicle and/or wheel reference speed that is independent of the wheel speed determined. Via an evaluation and control routine provided in the control unit, the deviation of the at least one wheel speed from the reference speed is determined and updated as a function of the determined deviation of the wheel circumference assigned to the at least one wheel.

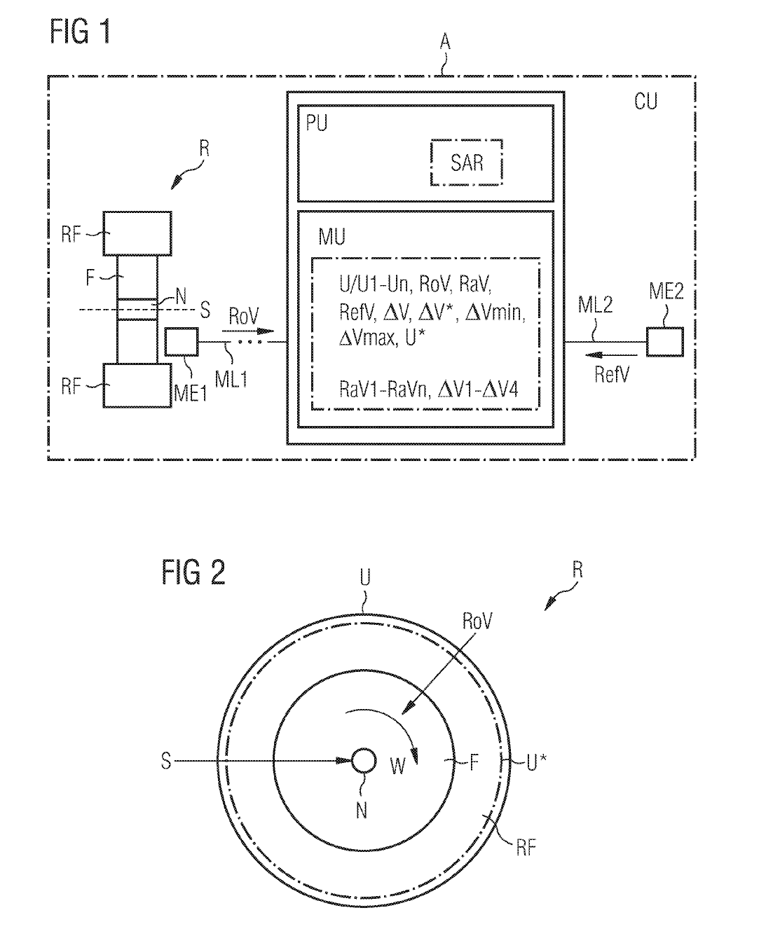

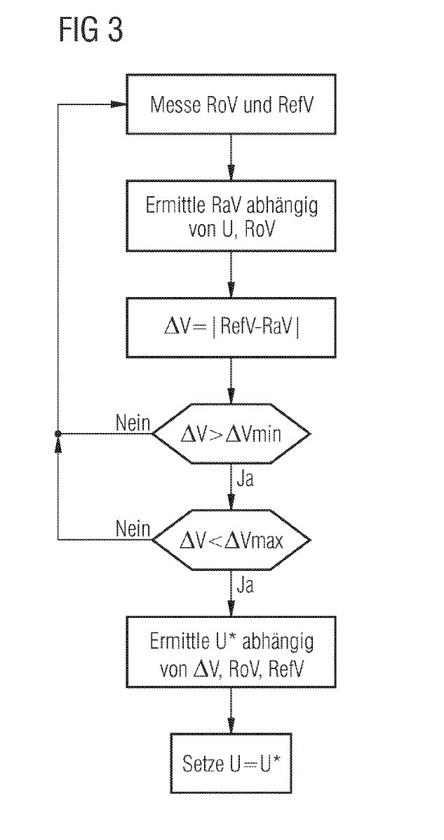

FIG. 1 shows, by way of example, a schematic block diagram of an arrangement A for determining the wheel circumference U of at least one wheel R mounted on a vehicle. FIG. 2 shows, by way of example, a schematic side view of the wheel R illustrated in FIG. 1, said wheel R exemplifying one of the four wheels R disposed on a vehicle which are rotatably mounted about an axis of rotation S, namely by means of a wheel hub N.

A wheel R consists of a rim F which surrounds the wheel hub N and is designed to accommodate a tire RF, the wheel circumference U of the wheel R corresponding to the outer circumference of the tire RF which can be very different depending on the type of tire R, the rim F, the wear of the tire tread and/or other effects such as the dynamic stresses caused by the vehicle or the driving behavior and/or the inflation pressure present. This results in an “effective wheel circumference” U of the wheel R which depends on the known environmental parameters. It is this circumference which is updated according to various embodiments.

The arrangement A additionally has a control unit CU with a processor unit PU and a memory unit MU, said processor unit PU being designed to implement a control and evaluation routine SAR. The control unit CU can be disposed in the vehicle, for example, as a separate control device or can be incorporated in control equipment already installed in the vehicle.

Also connected to the control unit CU shown in FIG. 1 is at least one first and second measuring unit ME1, ME2, namely by means of a first and second measuring line ML1, ML2. The first measuring unit ME1 is designed to determine the rotation speed RoV of the at least one wheel R and is preferably disposed directly adjacent to the wheel R to be measured. Alternatively, the first measuring unit ME1 can contain a plurality of sensor units (not shown in the Figures) which are each mounted immediately adjacent to the vehicle wheels R to be measured.

The rotation speed (“angular velocity”) RoV of the wheel R determined by the first measuring unit ME1 gives the change over time of the angle of rotation w referring to the rotation of the wheel R about the axis of rotation S and results from the time derivative of the measured angle of rotation. The measured rotation speed RoV is transmitted via the first measuring line ML1 to the control unit CU at a predefined instant, at cyclically repeating instants or continuously.

In the memory unit MU of the control unit CU there is stored at least one wheel circumference U which is predefined e.g. as the starting value for determining the wheel speed RaV as a function of the measured rotation speed RoV. In a preferred embodiment, a table with a plurality of different reference wheel circumferences U1 to Un is stored in the memory unit MU, these being assigned to different tire types.

If the wheel circumference U corresponding to the distance traveled by the wheel R during rotation through w=360° is known, the distance traveled in a predetermined time can be derived from the measured rotation speed RoV via the control and evaluation routine SAR in the processor unit PU. By evaluating the distance traveled per time unit, the wheel speed or more specifically wheel rotation speed RaV can be determined individually for each wheel. The wheel speed RaV determined is, for example, made available to other open- and closed-loop control systems (not shown in the Figures) in the vehicle. In particular, the current vehicle speed can be derived from the determined individual wheel speeds RaV of a vehicle.

The second measuring unit ME2 is provided for determining a reference speed RefV of the vehicle and/or of the wheel R which is independent of the wheel speed RaV determined. The measured reference speed RefV is transmitted via the second measuring line ML2 to the control unit CU and if necessary stored temporarily in the memory unit MU there.

The second measuring unit ME2 can be constituted e.g. by an accelerometer unit, an optical system and/or a global positioning/navigation system which each provide different measurement signals for deriving the reference speed RefV.

For example, if the second measuring unit ME2 is embodied as an accelerometer unit, the reference speed RefV is determined by integrating an acceleration signal measured in the direction of travel. In a preferred embodiment, the second measuring unit ME2 can be constituted by a multi-axis sensor cluster unit by means of which the gravitation effects occurring during acceleration measurement are suppressed.

Alternatively, the second measuring unit ME2 can be constituted, for example, by a global positioning/navigation system already present in the vehicle which determines the reference speed RefV in the form of a GPS speed signal or by evaluating two GPS position signals.

By way of example, the method according to an embodiment for determining the updated wheel circumference U, in particular an updated effective wheel circumference, will now be explained with reference to the flow chart shown in FIG. 3.

First the rotation speed RoV and the independent reference speed RefV of the at least one wheel R is determined via the first and second measuring unit ME1, ME2. The wheel speed RaV is determined by means of the control and evaluation routine SAR by evaluating the measured rotation speed RoV as a function of the wheel circumference U assigned to the wheel R in the memory unit MU.

The wheel speed RaV determined is now compared with the reference speed RefV provided by the second measuring unit ME2 and, for example, the absolute value deviation ΔV of the wheel speed RaV from the reference speed RefV is determined.

The deviation ΔV determined is compared with a minimum predefined deviation ΔVmin specifying, for example, a measurement tolerance threshold. If the predefined minimum deviation ΔVmin is undershot by the deviation ΔV determined, it must be assumed that the wheel speed RaV determined coincides with the reference speed RefV within the limits of the measuring error tolerance and therefore the wheel circumference U currently used for determining the wheel speed RaV corresponds to the effective wheel circumference U of the wheel R.

If the deviation ΔV determined exceeds the predefined minimum deviation ΔVmin, in the next step the deviation ΔV determined is [compared] with a predefined maximum deviation ΔVmax representing an upper threshold of the speed deviation due to an erroneous wheel circumference U. If the predefined maximum deviation ΔVmax is exceeded, it is assumed that the wheel speed RaV or reference speed RefV has been incorrectly determined and, under the control of the control und evaluation routine SAR, the deviation ΔV determined is discarded and a new measurement is initiated.

If the deviation ΔV determined is less than the predefined maximum deviation ΔVmax, the wheel circumference U stored in the memory unit MU is updated by the control and evaluation routine SAR as a function of the deviation ΔV determined. For this purpose, for example, the control and evaluation routine SAR calculates an updated wheel circumference U* from the rotation speed RoV measured by means of the first measuring unit ME1 and the reference speed RefV determined via the second measuring unit ME2 and replaces the stored wheel circumference U with the updated wheel circumference U*.

To increase the measuring accuracy and measuring certainty, the method described can be performed several times in succession and the wheel circumference U is only updated if the measurement result is confirmed after carrying out a predefined number of measurement cycles.

In another embodiment, the matching of the wheel speed RaV with the reference speed RefV is performed as a function of the relevant driving situation, i.e. the reference speed RefV and the rotation speed RoV are preferably determined at instants when correct matching is to be expected in the evidence of the first and second measuring units ME1, ME2 used.

For example, if the reference speed RefV is determined by means of a second measuring unit ME2 embodied as an accelerometer unit, the reference speed RefV is preferably measured in driving situations in which the vehicle exhibits an approximately constant acceleration over a predefined period of time. This can be the case, for example, when a vehicle moves off after stopping at a traffic signal.

In another preferred embodiment, the deviation ΔV of the wheel speed RaV from the reference speed RefV is determined on a current basis at different times t1 to tn and a mean deviation ΔV* is calculated from the deviations ΔV(t1) to ΔV(tn).

Once the current mean deviation ΔV* has been determined, subsequently determined deviations ΔV which differ markedly from the current mean deviation ΔV* are likewise discarded after comparison with same or rather another threshold value check is performed.

In a preferred embodiment, the deviation ΔV is determined individually for each wheel, i.e. a first to fourth deviation ΔV1-ΔV4 for each individual wheel R provided on the vehicle is determined by comparing the respective wheel speed RaV1 to RaV4 with the measured reference speed RoV.

According to another embodiment, the current wheel circumferences U* of the wheels R provided on the vehicle are determined approximately simultaneously and, if one or more of the current wheel circumferences U* deviate from the determined current wheel circumferences U* of the other wheels R, all the current wheel circumferences U* determined are discarded. As a result, a correlation of the wheel-specific measurement results takes place. If in this process, for example, one or more updated wheel circumferences U* are diagnosed, all the wheel circumferences U are re-determined.

The invention has been described above on the basis of an exemplary embodiment. Numerous variations and modifications are obviously possible without departing from the inventive concept underlying the invention.

List of reference characters

| | |
|---|---|
| A | arrangement |
| CU | control unit |
| F | wheel rim |
| ME1 | first measuring unit |
| ME2 | second measuring unit |
| ML1 | first measuring line |
| ML2 | second measuring line |
| MU | memory unit |
| N | wheel hub |
| PU | processor unit |
| R | wheel |
| RaV | wheel speed |
| RaV1 to RaV4 | first to fourth wheel speed |
| RefV | reference speed |
| RF | tire |
| RoV | rotation speed |
| S | axis of rotation |
| SAR | control and evaluation routine |
| U | wheel circumference |
| U1-Un | reference wheel circumferences |
| U* | updated, i.e. effective wheel circumference |
| w | angle of rotation |
| ΔV | deviation |
| ΔV* | current mean deviation |
| ΔV1 to ΔV4 | first to fourth deviation |
| ΔVmax | maximum deviation |
| ΔVmin | minimum deviation |

What is claimed is:

1. A method for determining an updated wheel circumference of at least one wheel disposed on a vehicle, wherein the at least one wheel is assigned at least one wheel circumference in a control unit and wherein the wheel speed is determined by means of the control unit as a function of the rotation speed of the at least one wheel and as a function of the assigned wheel circumference, the method comprising the steps of:
determining a reference speed of at least one of the vehicle and of the wheel which is independent of the determined wheel speed,
determining the deviation of the at least one wheel speed from the reference speed and determining the updated wheel circumference of the at least one wheel as a function of the deviation.

2. The method according to claim 1,
wherein the reference speed is determined by integrating an acceleration signal indicative of the acceleration of the vehicle.

3. The method according to claim 1,
wherein the reference speed is determined by evaluating a GPS speed signal or at least two GPS position signals via a global positioning system.

4. The method according to claim 1,
wherein the reference speed is determined by evaluating at least one of an acceleration signal and speed signal indicative of the acceleration of the vehicle provided by an optical system.

5. The method according to claim 1,
wherein at least one of the at least one wheel speed and the reference speed is determined as a function of the particular driving situation.

6. The method according to claim 1,
wherein the deviation of the at least one wheel speed from the reference speed is compared with at least one of a predefined minimum and maximum deviation and if the minimum deviation is undershot or the maximum deviation is exceeded by the deviation determined, at least one of the wheel speed and the reference speed is re-determined.

7. The method according to claim 1,
wherein a mean deviation is determined on a current basis by evaluating deviations determined at different times.

8. The method according to claim 7,
wherein
the deviation is compared with the current mean deviation and the deviation is discarded if a predefined value is exceeded or undershot.

9. The method according to claim 7,
wherein
the updated wheel circumference is determined as a function of the current mean deviation.

10. The method according to claim 1,
wherein a plurality of reference tire circumferences are stored in the control unit, one of the reference tire circumferences being assigned to a tire type in each case.

11. The method according to claim 1,
wherein
the current wheel circumferences of the wheels provided on the vehicle are determined approximately simultaneously and that if one or more current wheel circumferences deviate from the determined current wheel circumferences of the other wheels, all the current wheel circumferences determined are discarded.

12. An arrangement for determining the updated wheel circumference of at least one wheel mounted on a vehicle, comprising a control unit and at least one first measuring unit, wherein the at least one wheel is assigned at least one wheel circumference in the control unit, the first measuring unit being operable to measure the rotation speed of the at least one wheel, and the control unit being operable to determine the wheel speed of the at least one wheel as a function of the measured rotation speed and the assigned wheel circumference, wherein
a second measuring unit is provided for determining a reference speed of at least one of the vehicle and of the wheel that is independent of the determined wheel speed,
the control unit incorporates an evaluation and control routine for determining the deviation of the at least one wheel speed from the reference speed and for determining an updated wheel circumference as a function of the deviation determined.

13. The arrangement according to claim 12,
wherein the second measuring unit is constituted by an accelerometer unit.

14. The arrangement according to claim 12,
wherein the second measuring unit is constituted by a global positioning system or navigation system.

15. The arrangement according to claim 12,
wherein the second measuring unit is constituted by an optical system.

16. The arrangement according to claim 12,
wherein the reference speed is determined by integrating an acceleration signal indicative of the acceleration of the vehicle.

17. The arrangement according to claim 12,
wherein the reference speed is determined by evaluating a GPS speed signal or at least two GPS position signals via a global positioning system.

18. The arrangement according to claim 12,
wherein the reference speed is determined by evaluating at least one of an acceleration signal and speed signal indicative of the acceleration of the vehicle provided by an optical system.

19. The arrangement according to claim 12,
wherein at least one of the at least one wheel speed and the reference speed is determined as a function of the particular driving situation.

20. The arrangement according to claim 12,
wherein the deviation of the at least one wheel speed from the reference speed is compared with at least one of a predefined minimum and maximum deviation and if the minimum deviation is undershot or the maximum deviation is exceeded by the deviation determined, at least one of the wheel speed and the reference speed is re-determined.
